(19) United States
(12) Patent Application Publication
(10) Pub. No.: US 2024/0149463 A1
(43) Pub. Date: May 9, 2024

(54) Skydiving Robots

(71) Applicant: Mark Haley, McKinney, TX (US)

(72) Inventor: Mark Haley, McKinney, TX (US)

(21) Appl. No.: 18/052,927

(22) Filed: Nov. 6, 2022

Related U.S. Application Data
(63) Continuation-in-part of application No. 16/852,505, filed on Apr. 19, 2020.
Application No. 16/852,505 is a continuation-in-part of application No. 15/996,433, filed on Jun. 2, 2018, now Pat. No. 10,782,524.
(60) Provisional application No. 62/517,216, filed on Jun. 9, 2017.

(51) Int. Cl. B25J 11/00; B25J 9/16; B25J 15/00; B25J 19/02; G09B 9/00

(52) U.S. Cl. CPC B25J 11/002; B25J 9/1666; B25J 9/1676; B25J 9/1697; B25J 15/0009; B25J 19/023; G09B 9/003

(57) ABSTRACT

Device, system, and method for Skydiving Robots™ which can skydive using customized or off-the-shelf parachutes and deliver civilian or military payloads. The Skydiving Robots can freefall, open the parachutes and steer toward the target, carry payloads, operate in the daytime or the pitch black at night using GPS guidance to land precisely. If they exited the plane at up to or over 30,000 feet above ground level (AGL) the final target could be miles away. They are the ideal reconnaissance scouts with a wide array of sensors such as cameras. They can carry payloads and precisely land within a few feet of a target.

This application is a continuation-in-part application of and claims priority to U.S. patent application Ser. No. 16/852,505 entitled “Automatic Ejection Safety Technology with a Skydiving Simulator for Improving Pilot Safety”, filed on Apr. 19, 2020, the disclosure of which is incorporated herein by reference in its entirety.

### TECHNICAL FIELD

No Markups

Device, system, and method for Skydiving Robots™ which can skydive using off-the-shelf or customized parachutes and deliver military or civilian payloads, such as airdropping humanitarian supplies after disasters, such as earthquakes, floods, or forest fires. The Skydiving Robots can freefall, open the parachute and steer toward the target, carry payloads, operate in the daytime or the pitch black at night using GPS guidance to land precisely. If they exited the plane at up to or above 30,000 feet above ground level (AGL) the final target could be miles away. They are the ideal reconnaissance scouts with an array of sensors such as cameras and they can carry payloads and precisely land within a few feet of the target.

### BACKGROUND

Device, system, and method which permits Skydiving Robots to skydive, carry explosive or non-explosive payloads, and scout ahead of human skydivers, or to land simultaneously, during special ops or other military or nonmilitary missions.

Military free fall (MFF) offers the ideal method to insert personnel and supplies from transport planes. They fly at up to 35,000 feet or higher to avoid enemy surface to air missiles (SAM). Then the jumpers and supplies exit using either HALO (high altitude—low opening) or HAHO (high altitude—high opening). To permit the Skydiving Robots to scout ahead, the robots could use HALO, free falling at speeds up to or over 120 miles per hour and landing only 3 minutes after exiting the aircraft at up to or over 30,000 feet. On the other hand, the HAHO opening or some other variant such as opening at 15,000 feet (since the oxygen is limited), thereby ensuring that the Special Ops troops can hover longer while they wait for all clear from the scouting robots. If the landing site is clear, the skydivers would proceed to the target. If not, they could land at a backup site, miles from the original target.

HAHO jumps permit the skydivers to glide more than 40 miles from the drop point. And if the robots detect that the original targeted landing site has been compromised, the troops can continue to glide miles to a backup landing site.

The author of this patent, Mark Haley, was a Professor in Japan where he developed land and air robots including winning international competitions ranking in the top 6. Mr. Haley also authored a patent on the Skydiving Tracker which trains skydivers. The logic in that technology is a crucial part of the logic needed for the Skydiving Robots to precisely land at the target. In his original research Mr. Haley called Skydiving “A 6-minute dance with Death”. The combination of the Skydiving Robots with real Special Ops Jumpers is even more challenging and dangerous—it's a complex team effort like a complex dance ensemble between the robots and humans to complete missions safely and efficiently.

A Resupply System—The Skydiving Robots land precisely and quickly and are ideal to deliver supplies and the ideal scouts. At speeds of over 150 mph, they can maneuver in high winds and avoid enemy fire.

### BRIEF DESCRIPTION OF THE DRAWINGS

FIG. 1 Skydiving Robots (Overview)

FIG. 2 Skydiving Robots—Freefall, Open Chute, Steer Chute, Land

FIG. 3 Sample Ground Scout

FIG. 4 Flowchart Skydive Training (Human and/or Robots)

FIG. 5 Moving Robotic and/or Human Arms to control jumps in Simulations

FIG. 6 Practicing Simulations with Teams of Human and/or Robot Skydivers

FIG. 7 Standard and Vertical Freefalls during Skydives and Freefalls with Wingsuits

FIG. 8 Sample Jet stream from Los Angeles to Chicago

### DETAILED DESCRIPTION

This device, system and method offers an integrated method using Skydiving Robots to act as scouts ahead of the deployment of teams of skydivers. These humanoid robots would use off-the-shelf parachutes and weapons and act as the scouts ahead of mission or real skydivers—military or civilian. To enhance the capabilities of these robots on the ground, additional power units and or solar powered units could provide electric recharging for the robots thereby extending their active time on missions. For illustration purposes a solar panel is shown on the face of the Skydiving Robots. This could provide crucial backup if the batteries ran out before a crucial mission was complete.

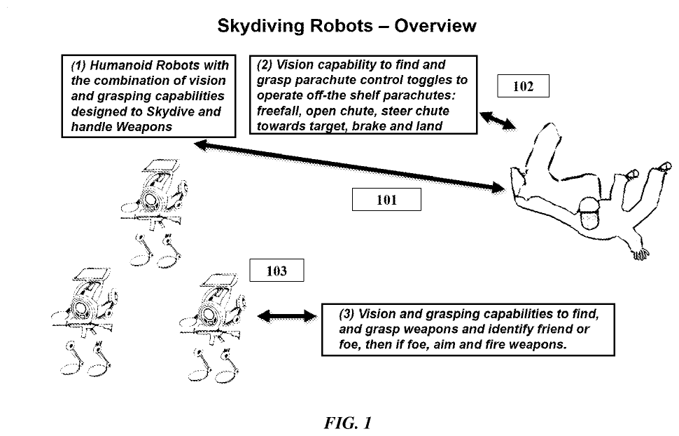

FIG. 1 shows the general capabilities of the Skydiving Robots, which permits these humanoid robots to use off-the-shelf military parachutes for jumps and standard weapons on the ground. Block 102 shows technical skills to operate off-the shelf parachutes: freefall, open chute, steer chute towards target, brake, and land. Block 103 shows the robots handling off-the shelf weapons.

However, the design of the robots would depend on cost considerations. For example, if it was too difficult and expensive for the robots to operate standard military weapons, a customized weapon might be needed. Also, while it's more cost effective to use standard military parachutes, a customized chute might also be needed. However, in general, robots can “see” with cameras and find and grasp control toggles and which then move its arms up and down—these are all the skills needed to operate chutes.

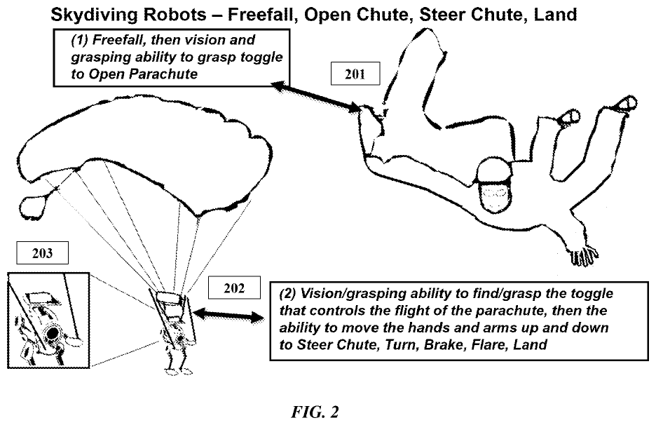

FIG. 2 shows the basic capabilities needed by a Skydiving Robot™. It must be able to move its arms, which are holding the chutes' toggles, up and down. When the arms are fully raised, the chute glides in a straight line at the maximum speed. If one arm moves down, the chute turns in that direction. If both arms are down to the waist, this is known as a half brake where the chute moves ahead but at a reduced speed. When both arms are fully down, this is known as full braking, or flaring, and the chute moves only slowly ahead. However, if the full brake is held for more than a few seconds, this creates a stall which can create a dangerous flight condition. Therefore, the robot's logic as with real skydivers has to include the ability to only gently apply full brakes during the final landing.

Blocks 201, 202 and 203 provide more illustrations of the skills needed by the Skydiving Robot. An inexpensive GPS system and other sensors including the implied wind speed, would provide guidance towards the target (low-cost GPS systems are available for a few hundred dollars). Then the robot must hold the parachutes' toggles and move them up and down by simply moving its arms up and down. When both hands are fully up the parachute glides forward at the maximum speed. When both arms are down this is a hard brake, and the parachute rapidly decreases in speed ultimately coming into a dangerous stall. With only the left or right arm down, the chute turns left and right respectfully.

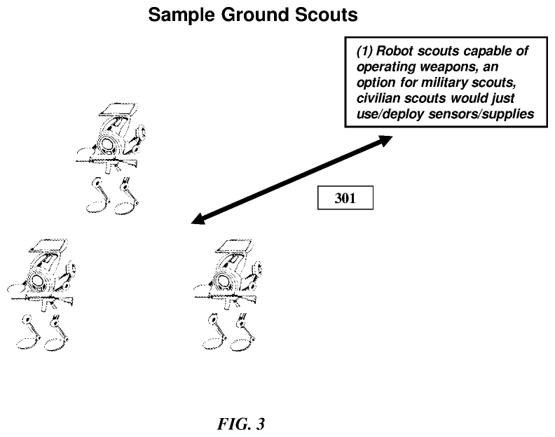

FIG. 3—Block 301. On the ground, a weapon, if needed, could be built into the robot. Resupply robots would be useful since they could deliver crucial extra supply supplies needed by the robots such as power units to recharge the Skydiving Robots and extra weapons and supplies for the humans (troops) being deployed on the mission. Analytical Software Inc. demonstrated a low-cost version which delivers payloads of 200 pounds.

Technological Challenges to Make the Skydiving Robot Cost Effective—A challenge is to have light-weight humanoid hands which can grasp a parachute control toggle and grasp a gun trigger. The second technological cost-effective challenge is to coordinate the vision capability of the robot with its hands providing the ability to find and hold the toggle and find and hold the gun. Finally, it needs the vision and grasping needs to identify friend or foe—either with simple networked links which identify the location of the human skydivers or a vision system which uses designed patches or a combination of both. Once those technological hurdles are complete, the Skydiving Robot could complete its scout mission, autonomously and cost-efficiently. In short, the Skydiving Robot needs the vision and grasping capabilities to grasp the toggles to control the parachute and move its arms up and down to steer the steer and land the chute and then find and grasp the weapons and identify friend or foe, then if foe, aim and fire weapons.

Expediting Implementation of the Technology in this patent—Mark Haley, the author of this patent, has an existing patent on training military and civilian jumpers to become expert skydivers on all types of military and civilian parachutes. The logic of this technology could be embedded into the Skydiving Robots thereby ensuring that these Skydiving Robots quickly became expert skydivers on all types of parachutes in all types of weather conditions around the role. A key feature is the ability to handle over a dozen emergency situations which often occur in skydives including failure of the parachute where a cutaway is needed, and the backup chute must be deployed. In short, the Skydiving Robot needs the same skydiving skills as a skydiver and the following provides more background on achieving this goal.

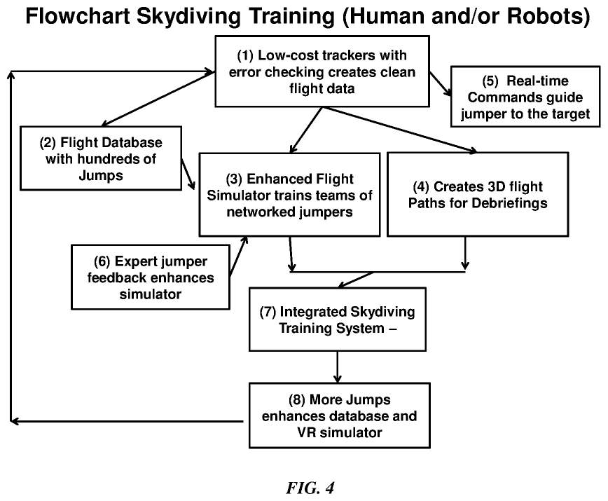

FIG. 4 highlights how the system: (1) dramatically improves training teams of skydivers (humans or robots) and (2) helps prevent the leading causes of skydiving deaths including mid-air collisions and landing in dangerous areas such as lakes or power lines. Collecting flight data of the jumps continues to improve the system. The skydiving flight data tracks and debriefs a planeload of jumpers (humans and/or robots) and was successfully used on hundreds of jumps and tracked and debriefed accidents in minutes where previously it took months to analyze accidents. It then plots this data into interactive maps of any locations worldwide so it can be used by skydivers.

FIG. 4 highlights one of the most important features is that it allows teams of 12 or more jumpers to train together. The GPS data from the 12 or more jumpers continuously updates the flight data database which is used for accident investigations and debriefings enhances the Virtual Reality simulator and even improves the error-checking of the data by cross-checking flight data between jumpers (you know the landing elevation and exit point so this helps the GPS data from 12 jumpers to be cross-checked and corrected).

In block 1, low-cost trackers from any of a wide range of trackers (widely used trackers for cars, hiking and digital watches and which could be customized for any proprietary systems) with our proprietary error-checking creates clean flight data (Latitude, Longitude, Altitude, etc.). There are a number of error-checking techniques from basic to more advanced which we use (the customer sees none of these and each time they start the program they agree not to reverse engineer our technology as part of the user's agreement—if they disagree, they can't start the program). GPS data can be flawed for a number of reasons. Usually multiple satellites provide this info, but as the ground is more cluttered with forests, hills, or mountains, less data is available and the latitude, longitude and altitude readings fail. Moreover, when the jumpers are in the plane sometimes where they sit also provides poor data. Our technology rates trackers. Some of the best-selling digital watches are not that good, and even the widely used trackers for cars or hiking give readings which show that the jumper was 300 ft. underground when they landed. Trackers continue to evolve and we rate and rank the best, least expensive options. For additional details on these error-checking techniques see the last pages before the claims.

The tracking data impacts four other features: In block 2 the flight data is continuously used to add to a Proprietary Skydiving database with detailed flight data on hundreds of jumps. In block 3 the flight data continuously enhances the Virtual Reality (VR) 3D Flight Simulator which permits teams of 12 or more jumpers networked to train together. In block 4 the flight data creates Stunning 3D Interactive Flight Paths of Jumpers/Aircraft for Debriefings/Accident Investigations. In block 5 the flight data provides optional real-time commands to the jumper to guide towards the target.

In block 6 feedback from expert jumpers is also used to continuously enhance the VR simulator. The net result of the continuously growing clean proprietary skydiving and other databases is an endlessly improving VR simulator and 3D mapping of flight data for debriefings and accident investigations: In block 7 a state-of-the-art training system for skydivers offers simulations before jumps, guidance during jumps and debriefings after jumps. Finally, in block 8 more jumps with more tracking improves training of jumpers, pilots, and spotters, and enhances the database and VR simulator.

What makes this technology unique is: (1) low-cost trackers from $100 and also it can be customized for expensive trackers which provide clean flight data (using our technology to clear up GPS data which has many errors); (2) using this flight data for accident investigations, jump debriefings and for reliable data for the Virtual reality simulator (robots and human would jump together, practice together and debrief together); (3) the related maps to continuously monitor teams in the air and on the ground for the simulation or real missions; (4) the simulator uses both this data plus feedback from expert jumpers on many types of parachutes, such as round chutes, an older technology and precise faster RAM chutes, now widely used; and (5) using a state-of-the-art system which trains teams of skydivers with networked realistic interactive jumps using commercially available 3D low-cost maps available on PCs or cell phones.

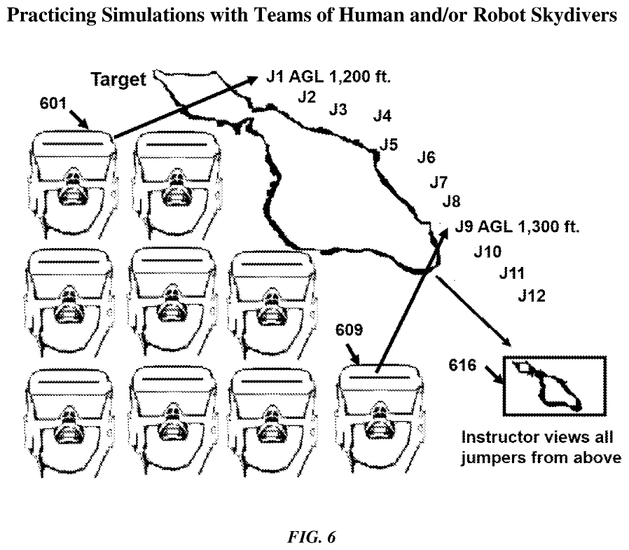

One of the most important features of our system is that we network teams of jumpers where they just put their headsets on, each with a $500 device, so teams of 12 jumpers, robots and/or human, can train together (FIG. 6) where the virtual 3D world could also be projected on screens, such as a TV or projector, to permit observers to see/evaluate the jumpers.

Key components and contributions of the system include methods for efficient data consolidation from multiple sensors and immediate intuitive feedback. These provide rapid training, real-time tracking and status notification, and post-jump accident investigation and flight debriefing for skydivers. The system also incorporates a simulator which can be used prior to jumps. Quantitative and qualitative evaluation was performed on real jumps (over four hundred total jumps), the results of which are encouraging towards the use of this system for all skydivers from training to post-jump feedback. For real-time data acquisition, an all-inclusive approach to jump analysis is utilized, whereby data from GPS, a priori topological terrain data, flight path, and pilot and spotter information are all consolidated to rapidly inform qualitative feedback to the jumper. This low-cost approach is robust compared to poor global positioning system (GPS) readings by leveraging multiple types of inexpensive, lightweight sensors and a rule-based classifier to isolate and extrapolate only reliable sensor information from hundreds of thousands of relevant data points. The method is furthermore extendable to and improved with multiple simultaneous jumpers—more jumpers provide additional data for cross-checking and consistency. In addition to novel data acquisition and processing, the system extracts relevant data and transforms the data into intuitive, 3D visual feedback during or almost immediately following the jump. 3D aircraft flight path, jump path and landing accuracy are just a few of the analytical capabilities which are generated immediately.

Technical improvements to the jumpers are also calculated and displayed. Such information is useful, for example, to debrief both spotters and jumpers to prepare for safely and accurately landing on target. The tracking system is also amenable to various types of tracker sensors and hardware and can thus provide a basis for quantitative comparison between hardware as it relates to skydive tracking. In contrast to the proposed system, other currently implemented methods rely on single-modality sensing and expensive, non-robots tracking equipment and procedures, and can require months of analysis and data refinement before accident investigations can be reliably conducted. The method is furthermore extendable to and improved with multiple simultaneous jumpers—more jumpers provide additional data for cross-checking and consistency. A 2016 injury was analyzed within fifteen minutes after receiving flight data, and detailed 3D flight path, data and graphics were generated. It isolated the cause of the accident, showed the best camera angles for the jump, and simultaneously displayed the flight data while also evaluating jumpers, spotters, and pilots. Also, data was collected from twelve jumpers during their rookie training and from veteran jumpers. This consisted of seventy-five individual jumps over two weeks, and the tracked data provided quantitative evidence of diver skill improvement using the intelligent tracking system. With the tracking and feedback system, rookie jumpers overall doubled their landing accuracy between the first and second week of jumps.

The inventor developed the “Skydiver Tracker”, which is skydiving training/safety technology. It has been purchased and successfully field-tested in hundreds of jumps by the U.S. government and as noted by a skydiver training manager, it allows them “to help teach parachute manipulation to new jumpers and refine techniques for experienced jumpers . . . Your concept of a GPS-guided cargo delivery system is of interest to us” since “being able to stay at a higher altitude to deliver cargo packages would lower our mission risk.”

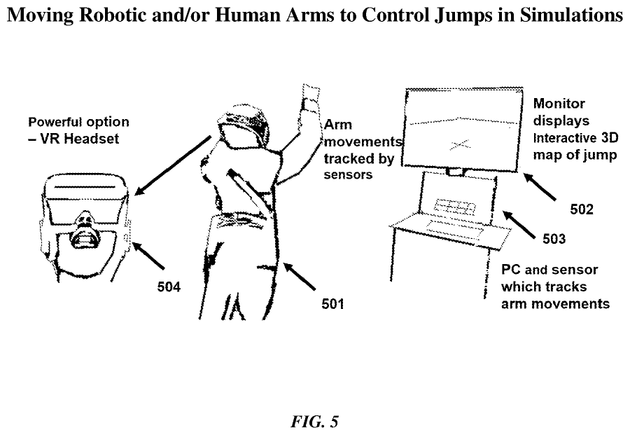

These interrelated technologies transform skydiving training/safety with: (1) a Virtual Reality (VR) simulator which permits practicing simulated jumps anywhere in the world prior to a real skydive and (2) two ounce $100 trackers which create actual flight data/3D graphics for post-jump debriefings/accident investigations far beyond existing capabilities as shown in the jump into the Grand Canyon. It should be used on every jump for humans and/or robots, especially during teamwork training. This black box (low-cost trackers with additional options) provides flight data and interactive 3D maps and videos which can be: (1) used for debriefings for the spotter, pilot, and jumpers after skydives; and (2) it provides crucial flight data for accident investigations. The headset and sensors permit the user to move their arms as in real skydives and practice jumps anywhere in the world. FIG. 5 shows a smokejumper (in gear) 501 training on our non-Virtual Reality (VR) version, but a more powerful option shows a VR Headset 504 where no display 502 is needed. The sensor 503 tracks the users' arm movements like a real skydive. The jumper pulls imaginary (or real) toggles which control the chute. If their arms are straight up, they fly at the maximum speed straight ahead but if one arm, i.e., the left, is down they turn left.

Team Training—The training is also for a team of 12 or more jumpers which includes any combination of humans and/or skydiving robots. FIG. 6 shows how low-cost Jump VR Simulators (601, 609) can be set up in minutes to train a team. The skydiving instructor sees all the jumpers in a top-down daytime view with their flight data and all topography on a 3D color map on the screen 616. Due to space limitations, FIG. 6 only shows 12 skydivers on the map (Jumpers J1-J12) and the headsets of 9 members of the team who are practicing together. The team could train in the same room or worldwide on a network. During this mission they are circling an island. For night jumps, each jumper's headset only shows a pitch-black sky with small indicator lights to avoid each other.

Skydiving Robot which carries Explosive Payloads—A crucial final feature of the skydiving robot is to include the option to have it carry explosives, i.e., bombs, or nonexplosive payloads, which the robot could precisely deliver into enemy territory. The robot could use its skydiving capability to skydive over 30 miles after exiting the aircraft where the exit elevation is up to 25,000 feet or more, i.e., the exit point above sea level. The robot could carry bombs weighing hundreds of pounds which is possible using off-the-shelf military parachutes since special ops human skydivers often carry hundreds of pounds of payloads of supplies during their jumps. However, when human skydivers carry extra supplies, they drag them beneath them which slows up the speed of the parachute. Fortunately, the skydiving robot could be designed to be relatively light, i.e., less than 100 pounds, and the explosives could be placed in aerodynamically designed spaces within the robot's body and/or legs to easily carry over 150 lbs. of explosives. Then the robot could weigh 250 pounds or more, similar to the weight of a human and the robot would be aerodynamically built to minimize drag and thereby maximize its speed as it glided up to or over 30 miles within enemy territory. Using a robot's precise skydiving capability, it could land within a few feet of the target thereby permitting robots either acting alone or with teams of robots to precisely bomb enemy targets up to 30 miles or more behind enemy lines, ideally at night to avoid enemy detection. Another option for the skydiving robot would be to land without detonation and then serve as a scout before humans skydive or before attacks on the enemy to ensure precise deployment of troops and/or bombing. Whenever the enemy approached too closely to the scout robot on the ground—it would then detonate its bomb to both attack the enemy and to avoid giving the enemy any valuable technical information about the robot.

Deploying the Skydiving Robot—While for safety the aircraft deploying the robot could stay away from enemy lines, if the aircraft flew into enemy territory to deploy the robot, then the robot could land hundreds or even thousands of miles behind enemy lines, covering literally every part of any country in the world. And if the aircraft deploying the robot was an autonomous unmanned vehicle, no human would need to risk their lives in the mission of deploying the skydiving robot. Finally, and if the skydiving robot was deployed in a HALO (high altitude—low opening) mission, the robot could exit the aircraft at up to or over 30,000 feet and then freefall at a terminal speed of roughly 120 miles per hour and land within a few feet of the target in only 2 or 3 minutes, thereby becoming an extremely difficult target to shoot down.

GPS denied environment—While GPS inexpensively guides the robot to the target, backup options in GPS denied environments include Visual Aided Navigation, which includes cameras and maps, Celestial Navigation which tracks stars or Micro-electromechanical systems (MEMS) and Inertial Measurement Units (IMU).

Simulated Free Falls—Skydives include the free fall before the parachute opens followed by steering the chute to landing (FIG. 2). Wind tunnels permit free falls training for as little as $100 per jump, however they lack the headset related to the Skydiving Tracker shown in FIG. 5. Networked Virtual Reality headsets which display a virtual 3D world and which track the movements of a jumper's arms and legs permit practicing simulated free falls for teams of humans and/or skydiving robots using either a wind tunnel or without the wind tunnel since the headset tracks their arm/leg movements whether they are floating horizontally in the wind tunnel or standing up permitting the jumpers to practice missions worldwide including HALO or HAHO jumps and continuing the simulation after the parachute opens tracking a complete mission from exiting the aircraft to landing where the virtual 3D world could also be projected on screens, such as a TV or projector, to permit observers to see/evaluate the jumpers.

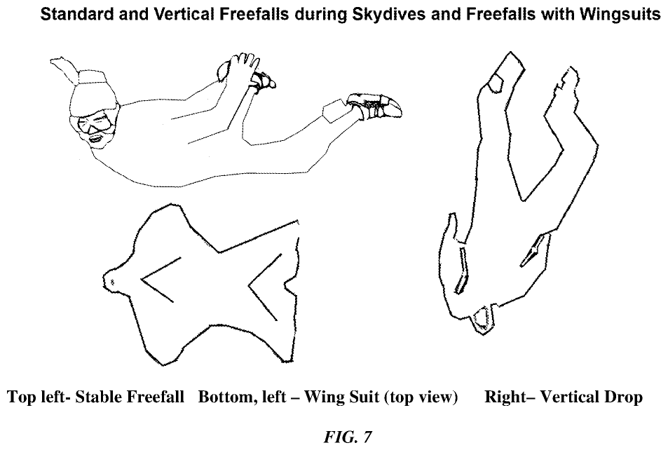

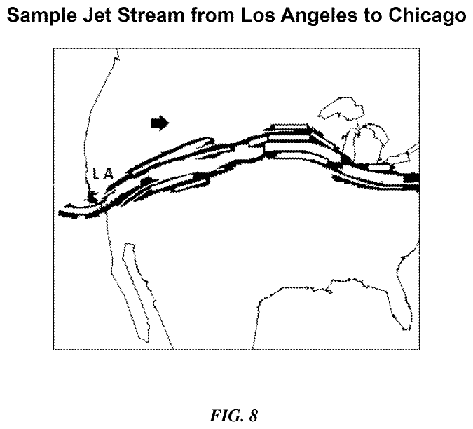

Weather type or others balloons to deploy robots—Hundreds of skydiving robots, costing as little as $10,000 ($2023) or less each, could be deployed by a large military transport aircraft. However, air defense systems use missiles which cost up to or over $200,000 each, to destroy aircraft which cost up to or over $100 million, effectively creating no fly zones. An alternative deployment, ideally at night, would be balloons, which carry payloads up to or over 8.000 lb., carrying unmanned aerial vehicles (UAVs), skydiving robots, etc., to altitudes up to 160,000 feet. Jet streams, which have speeds of up to or over 250 mph, which exist between roughly 30,000 feet and 50,000 feet, and usually flow from west to east and can be predicted by meteorologists, provide cost effective penetration of air defense systems precisely landing anywhere along jet streams worldwide. The jet streams vary from location to location and change from day to day. FIG. 8 shows that a balloon launched into a jet stream of 100 mph in LA could theoretically reach Chicago within about 18 hours. Pilots fly with jet streams to fly faster or above them to avoid headwinds. Skydiving robots, which could be as small as or smaller than 5×2×1.5 ft., which are smaller than UAVs, powered or gliders, which are easier to shoot down. The robots would be aerodynamics designed to maximize speed like human skydiving speed record holders and freefall from up to or over 80.000 ft. reaching the target in minutes and use a technique called tracking, where skydivers change their body position to turn, or move horizontally, which can be practiced using a simulator such as the Skydiving tracker and/or real jumps permitting robots to precisely land without opening the parachute. Wind tunnels aren't ideal for horizontal training. FIG. 7 (top left) shows a skydiver in an aerodynamically stable position where there is no horizontal movement. If the skydiver puts their arms next to their body and their legs together straight out like a guided missile, they could move up to or over 180 mph horizontally and up to or over 300 mph vertically (FIG. 7, right, poor form). If the mission was to crash an explosive into the target, a parachute would not be needed, significantly reducing the cost and complexity of the robots. However, a backup parachute with a standard Automatic Deployment Device (ADD) could be used to handle robotic freefall malfunctions. This amazing technology provides precision landings within 50 ft. of targets, worldwide, thousands of miles away using a robot which costs as little as $5,000 or less. While wingsuits FIG. 7 (bottom left-top-down view) with horizontal speeds of up to or over 240 mph could be used, only retractable wings would permit holding at 0 mph horizontally which can help in pinpoint landings.

What is claimed is:

1. A system for Skydiving Robots™ to skydive like humans using off-the-shelf or customized parachutes where the robots grasp the chute's toggles which open and then control the chute and then move their arms up and down like humans to turn, steer and land near the target, where the jump can begin at up to or over 30,000 feet above ground level (AGL) with a system comprising:
human like hands for the robots to permit grasping the chute's toggles which open the chute and steer and operate the parachute and optionally to operate weapons for military missions; and
a Global Positioning Sensor (GPS) and other sensors including the implied wind speed, which tracks the skydive and indicates the Skydiving Robot's position relative to the target to permit the robot to steer and land near the target using arm and hand movements to control the chute's control toggles similar to a real skydiver where the chute's movement is controlled by a jumper moving their arms up and down which turns and controls and sets the speed of the parachute; and
a computer vision camera system which permits the robot to find and pull the toggle which opens the parachute and control toggles for the parachute and then guide the humanoid hand to grasp the toggle and simply pull it down and up with the robot's arm movements to steer, turn and control the chute's speed and flare and land and during emergencies find cutaway and pull the reserve parachute; and
use a technique during freefall called tracking, where skydivers change their body position to turn, or move horizontally, which can be practiced using a simulator and/or real jumps permitting robots to precisely land and if the robot, like a human, is in an aerodynamically stable position there is no horizontal movement however if the skydiver puts their arms next to their body and their legs together straight out like a guided missile, they could move up to or over 180 mph horizontally and up to or over 300 mph vertically.

2. The system of claim 1 further comprising: the robot's ability to skydive, and carry civilian or military payloads, using military and civilian parachutes and handle over a dozen emergency situations which can occur in skydives including failure of the parachute where a cutaway is needed and the backup chute must be deployed where this capability is provided by the robots ability to use its robotics hands to grasp the toggles, to cutaway the primary chute and deploy the backup chute and the ability to use the robot's cameras to track and avoid collisions with other skydivers where this ability is programmed after simulations with teams of skydivers and the ability to choose alternative landing sites using its cameras to detect clear landing areas in case the primary site is deem unreachable and/or unsafe.

3. The system of claim 1 further comprising: a low-cost, low-bandwidth, long-rang digital radio or a network for real-time communications with the ground, other skydivers or with aircraft flying which provides continuously updated data for real-time 3D maps (either simulated or real) of personnel both in the air or on the ground, which is crucial in missions where their cell phone communications failed whereas this system can provide real-time tracking of a team to ensure the success of the mission where this data can be integrated into broader secure cell or other networks plus the option in GPS denied environments to guide the robot using alternatives such as Visual Aided Navigation, which includes cameras and maps, Celestial Navigation which tracks stars or Micro-electromechanical systems (MEMS) and Inertial Measurement Units (IMU).

4. The system of claim 1 wherein this data creates a virtual reality skydiving simulator with a headset, or without a headset which uses a display, which is continuously improved by a tracker database plus feedback from expert skydivers so that after missions the robot's movement and accuracy can be tracked and reviewed to continuously improve the capabilities of the skydiving robots.

5. The system of claim 1 further comprising: virtual reality headsets for immersion into a 3D world which is portable with just a PC, where some standalone headsets don't require PCs, and where the virtual 3D world could also be projected on screens, such as a TV or projector, to permit observers to see/evaluate the jumpers. and the where the headset or sensors track arm movements (which is how the jumper controls their turns and speed) and the user explores by simply turning your head for a unique trainer system which simulates round and ram-air chutes anywhere in the world and can inexpensively and compactly be used in planes while flying to their missions for teams of military or other skydivers, using deployment techniques such as High Altitude High Open (HAHO) jumps at altitudes of over 30,000 ft. and also night jumps.

6. The system of claim 1 further comprising: shared simulated flight data over a network either locally or remotely with the option to view night or day jumps and see and train over 12 jumpers with robots at the same time, which is a key requirement for elite units to practice close formations to avoid collisions and preform as a team which existing technology fails to address; and this technology cost-effectively permits teams of 12 or more jumpers to practice and immediately begin missions to train with the Skydiving Robots.

7. The system of claim 1 further comprising a control system where the human skydivers can override the Skydiving Robot's movements if plans change during a mission.

8. The system of claim 1 further comprising the option to use existing robotics resupply systems to deploy the Skydiving Robots if a simpler deployment option is recommended based on the capabilities of the skydiving robot vision and grasping limitations where the Skydiving Robot would have to simply extricate itself from the resupply robot once it landed and the Skydiving Robot could continue its mission to scout ahead of human skydivers.

9. The system of claim 1 further comprising a computer vison camera system which permits the robot to find, and with the humanoid hand grasp a weapon and then to identify with vision and/or a network capabilities to identify friend or foe, and if foe, the grasping hand has aiming capability to fire weapons at the foe with multiple backup checks to confirm the only time the weapon is fired is when a vision and/or networked capabilities or combination thereof identifies friend or foe, robot or humans and also the ability of the robot to walk, knell, lay down like humans so it maintains the optimal defensive position while it fires a weapon or to avoid being hit by the enemy's weapons.

10. The system of claim 1 further comprising the vision ability combined with the arm movement capability of the robot to steer away from other skydivers in the air which come closer than a set range and on landing to avoid objects such as trees.

11. A method for Skydiving Robots to skydive like humans using off-the-shelf or customized parachutes where the robots have cameras which permit them to find and grasp the control toggles for parachutes and then move their arms and humans up and down like humans to control the toggles which operate the parachute allowing it to turn and glide and land near the target, where the jump can begin at up to or over 30,000 feet above ground level (AGL) and where the robots can land ahead of humans on skydives to scout ahead on the landing before the human skydivers land and the similar ability to find and grasp weapons and then aim and fire these weapons at the enemy.

12. The system of claim 1 further comprising: the ability of the skydiving robots to include a payload of explosives, i.e. bombs, which could explode on impact after the robot precisely landed where the bombs could weigh hundreds of pounds using parachutes and where these explosives could be placed in aerodynamically designed spaces in the robot's body and/or legs to ensure it glides at the maximum speed, while human special ops skydivers (Special Operators or Special Forces) often carry hundreds of pounds of supplies beneath them which reduces the parachute's speed, while the aerodynamically sleek robot could glide more rapidly over 30 miles from the exit point of the aircraft when deployed up to 25,000 feet or higher elevation, i.e. above sea level, and then precisely landing within feet of the target, ideally deployed under the cover of darkness to avoid enemy detection, and the additional option to land without detonation, and to act as a scout and them explode when the enemy comes to close, i.e. within 70 or more feet of the robot.

13. The system of claim 1 further comprising: the option to fly an aircraft deep behind enemy lines when deploying the skydiving robot so the robot could land hundreds or even thousands of miles behind enemy lines, covering literally every part of any country in the world and if the aircraft deploying the robot was an autonomous unmanned vehicle, no human would need to risk their lives in the mission of deploying the skydiving robot and if the skydiving robot was deployed in a HALO (high altitude—low opening) jump, the robot could exit the aircraft at up to or over 30,000 feet and then freefall at a terminal speed of up to or over 120 miles per hour and land within a few feet of the target in only 2 or 3 minutes, thereby becoming an extremely difficult target to shoot down.

14. The system of claim 1 further comprising: the option with networked Virtual Reality headsets which display a virtual 3D world and which track the movements of a jumper's arms and legs permit practicing simulated free falls for teams of humans and/or skydiving robots using either a wind tunnel or without the wind tunnel since the headset tracks their arm/leg movements whether they are floating horizontally in the wind tunnel or standing up permitting the jumpers to practice missions worldwide including HALO or HAHO jumps and continuing the simulation after the parachute opens tracking a complete mission from exiting the aircraft to landing where the virtual 3D world could also be projected on screens, such as a TV or projector, to permit observers to see/evaluate the jumpers.

15. The system of claim 1 further comprising: the ability of skydiving robots or unmanned aerial vehicles (UAVs) to be deployed by aircraft or more effectively by weather type or others balloons launched, ideally at night, which can evade air defense systems which use missiles to destroy aircraft, where these balloons can carry payloads up to or over 8,000 lb., to altitudes up to or over 160.000 feet and use the jet streams, which have speeds of up to or over 200 mph, which usually flow from west to east, thereby permitting precise landings anywhere along jet streams worldwide where skydiving robots, which could be as small as or smaller than 5×2×1.5 ft., which are smaller than UAVs, powered or gliders, which are easier to shoot down and the robots would be aerodynamics designed to maximize speed like human skydiving speed record holders and freefall from up to or over 80.000 ft. reaching the target in minutes and during freefall use a technique called tracking, where skydivers change their body position to turn, or move horizontally, which can be practiced using a simulator and/or real jumps and if the robot, like a human, is in an aerodynamically stable position there is no horizontal movement however if the skydiver puts their arms next to their body and their legs together straight out like a guided missile, they could move up to or over 180 mph horizontally and up to or over 300 mph vertically and, if the mission was to crash an explosive into the target, a parachute would not be needed significantly reducing the cost and complexity of the robots, however a backup parachute with a standard Automatic Deployment Device (ADD) could be used in case of robotic freefall malfunctions and while wingsuits with horizontal speeds of up to or over 240 mph could be used, only retractable wings would permit holding at 0 mph horizontally which can help in pinpoint landings.
